(19) United States
(12) Patent Application Publication
(10) Pub. No.: US 2024/0053965 A1
(43) Pub. Date: Feb. 15, 2024

(54) METHOD FOR MODIFYING A SIGNAL PROCESSING CHAIN

(71) Applicant: dSPACE GmbH, Paderborn (DE)

(72) Inventor: Joerg NIERE, Paderborn (DE)

(73) Assignee: dSPACE GmbH, Paderborn (DE)

(21) Appl. No.: 18/232,923

(22) Filed: Aug. 11, 2023

(30) Foreign Application Priority Data
Aug. 11, 2022 (DE) 10 2022 120 339.5

(51) Int. Cl. G06F 8/34

(52) U.S. Cl. CPC G06F 8/34

(57) ABSTRACT

A method for management of components of graphical diagrams in a platform for processing signals from multiple sensors, at least one component can be present in a first mode, for example Rapid Control Prototyping, and can be absent in a second mode, for example source code generation. Moreover, components that are used only by the absent component can also be deleted in the second mode. The information about the components can be stored in a configuration profile.

This nonprovisional application claims priority under 35 U.S.C. § 119(a) to German Patent Application No. 10 2022 120 339.5, which was filed in Germany on Aug. 11, 2022, and which is herein incorporated by reference.

### BACKGROUND OF THE INVENTION

### Field of the Invention

The present invention relates to the processing of sensor data on the basis of an interconnection of at least two components, which interconnection is specified in a block diagram.

### Description of the Background Art

Control units are used in a multitude of applications in order to sense physical quantities of a process and/or to influence a process by means of connected actuators. The time constants that determine the dynamic behavior of the process often require cycle times of 1 ms or less, so that a real-time capability of the control unit generally is necessary: in particular, changed sensor values must be reacted to within a predetermined maximum latency. For a driver assistance function in a motor vehicle, it is generally the case here that the data from a multiplicity of different sensors must be merged, such as, in particular, environmental sensors like cameras, radar sensors, and/or LIDAR sensors.

In order to accelerate the design of control units, control strategies are frequently implemented with the aid of development environments that specify the interconnection of the sensors in a block diagram. The individual blocks or components allow the incorporation of code in different programming languages. In addition, there are frequently ready-made components, which include, for example, drivers for controlling different sensor types. The block diagram can be executed in a runtime environment that provides time synchronization of the data streams. One example of such a development environment is RTMaps from Intempora.

In a first step, the development of a multi-sensor application can take place on a host PC, for example in that a camera is connected by USB or the data from a GPS receiver are received through a serial interface. In this case, different sensors from those in the production vehicle are often used. In addition, components developed specifically for use on a host PC, such as display screens, flexible data displays, or even oscilloscopes, can be employed. If no sensor is present, playback components, which supply stored sensor data, can be used instead. Storage of received sensor data in a recording component is also possible.

In a second step, the multi-sensor application is generally tested by Rapid Control Prototyping (RCP), which is to say is used in a real environment on an RCP system or on an especially powerful control unit suitable for development. To this end, the development environment can provide different runtime environments that are optimized for the RCP system in question. A recording or the playback of data can frequently be maintained through an abstraction of the operating system interface that is present in the component. The block diagram can be reused to a large extent, but some components must be manually replaced or removed: thus, the camera image can continue to come through a USB port, but with a different camera being used. It may also happen that the GPS receiver is now connected through a CAN bus or Automotive Ethernet bus. In addition, one or more sensors may be integrated in the RCP system and require different drivers. Display components are superfluous or are not supported on the RCP system.

In the prior art, the block diagram must be adapted manually every time the hardware platform is changed. When the development requires multiple changes between the host PC and the RCP system, for example on account of faults that have occurred, the changes must be made repeatedly.

### SUMMARY OF THE INVENTION

It is therefore an object of the present invention to make it easier to adapt the signal processing chain specified in a block diagram to different hardware platforms.

A computer-implemented method is thus provided for modifying a signal processing chain that is implemented in a block diagram by means of components connected by signal lines, wherein the block diagram includes at least one signal source and at least two components that are connected directly or by interposed components to at least one of the signal sources. The method includes the steps: reading the block diagram into a development environment, selecting a mode from at least two existing modes, wherein the signal processing takes place on a first hardware platform in a first mode and the signal processing takes place on a second hardware platform in a second mode, wherein the first hardware platform and the second hardware platform are designed differently, and removing or replacing at least a first component from the block diagram if the second mode was chosen.

The first hardware platform can be, for example, a host PC, which can be equipped with a display and control elements; the second hardware platform can be, in particular, an RCP system. The RCP system can be a prototype control unit but can also be a production control unit.

The method can further include the removal of at least one additional component if the first component was removed and the additional component was connected solely to the first component on the output side. When the output or outputs of an additional component are not reused, then it can be eliminated as well. Doing this automatically further accelerates the adaptation of the block diagrams. Provision can be made to carry out the analysis one time for identifying the components to be removed and to store the result in a configuration file. A repeated analysis then does not have to take place until after a manual editing of the block diagram.

An iterative removal of components that are no longer required may take place. Thus, a check can first be made as to whether a component was removed in the last step, and then the remaining components can be checked for unconnected outputs. If it is established in this process that all outputs of a now orphaned component are unconnected, then the orphaned component can be removed. In a next step, a check can be made as to whether the removal of the orphaned component resulted in a new component being orphaned because all outputs are unconnected. This check can be continued until no more components with unconnected outputs have been found and removed—there then can also be no components that are no longer needed on account of unconnected outputs.

By preference, the selection of a mode may take place automatically on the basis of a hardware platform that executes a runtime environment of the development environment. The hardware platform can be determined on the basis of a processor type or a unique processor identification number, for example. Alternatively, or in addition, the hardware platform can be identified on the basis of one or more connected devices, in particular one, more, or all connected sensors. Provision can also be made to calculate a checksum from the serial numbers and/or model numbers of devices present on the hardware platform as a hardware ID and, in particular, to compare it with a value stored in the profile. The runtime environment can provide a function for selection of the mode and/or identification of the hardware environment in an application programming interface (API).

It is advantageous when a third mode can be selected through the development environment, wherein the third mode includes an execution on a third hardware platform, in particular a production control unit, and wherein a generation of source code from the block diagram additionally takes place in the third mode. In the third mode, provision can be made that the signal processing chain is executed on a hardware platform without using a runtime environment. The user can select this mode in order to start a generation of source code. The generated source code can be compiled with a cross-compiler for the third hardware platform. The generated binary file can be stored on the non-volatile flash memory of a production control unit, for example.

The method can include a reading of a configuration file, wherein the configuration file includes at least one mapping of a component of the block diagram onto another component or a mapping onto an empty component, which is to say a removal of the component, and wherein the at least one mapping is specific for one mode. This allows the user to store the changes that are to be made as a configuration file once and to subsequently have them carried out as often as desired. The configuration file does not have to be changed until a component is replaced and/or changes to the hardware platform occur or become necessary. Storing multiple configuration files makes it possible to support a multiplicity of modes or hardware platforms. Preferably, one configuration file per mode is stored in this case; in principle, however, it is also possible to store all modes in one configuration file with multiple sections.

The development environment can include a runtime environment that is equipped to provide signal data received through a signal source with at least one time stamp, and wherein the components and/or the runtime environment are equipped to process signal data in a synchronized manner. The runtime environment can provide a fixed range of functions, which remains constant on all hardware platforms, for synchronization of the signals.

The modification of a signal processing chain can take place automatically within the framework of a test. A method for testing a control unit with the following steps is thus provided: opening a block diagram on a first hardware platform, in particular a host PC, wherein at least a first signal source in the block diagram is executed as a playback component; executing the block diagram on the first hardware platform in order to obtain at least a first result; comparing the first result with a test condition, and if the first test condition is met; reading a configuration file that includes a mapping of the first signal source to a component for controlling a real sensor; adapting the block diagram on the basis of the configuration file, wherein the adaptation of the block diagram includes the replacement of the playback component by the component for controlling a real sensor; downloading the modified block diagram to a second hardware platform, in particular an RCP system; and/or executing the block diagram on the second hardware platform in order to obtain a result based on real sensor data.

A seamless transition between a data replay test of a control algorithm and testing under real conditions is made possible by the method according to the invention.

The invention further relates to a method for configuring a control unit, wherein the control unit includes at least one computing unit and preferably has at least one sensor and/or at least one actuator in order to sense data of a physical process and/or to influence said process, the method comprising the steps: generation of a source code with a method according to the invention; compiling of the source code for the computing unit so that executable code is generated; transmission of the executable code to the control unit; and storing of the executable code on a non-volatile memory of the control unit and/or execution of the executable code by the computing unit of the control unit.

The invention further relates to a computer program product with a computer-readable storage medium on which are embedded instructions that, when they are executed by a processor, cause the processor to be equipped to carry out a method according to the invention.

In addition, the invention relates to a computer system comprising a human-machine interface, a non-volatile memory, and a processor, wherein the processor is equipped to carry out a method according to the invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is an example of a computer system,

FIG. 2 is a schematic representation of a development environment,

FIG. 3 is a first example of a block diagram for processing sensor data,

FIG. 4 is a second example of a block diagram for processing sensor data, and

FIG. 5 is a third example of a block diagram for processing sensor data.

### DETAILED DESCRIPTION

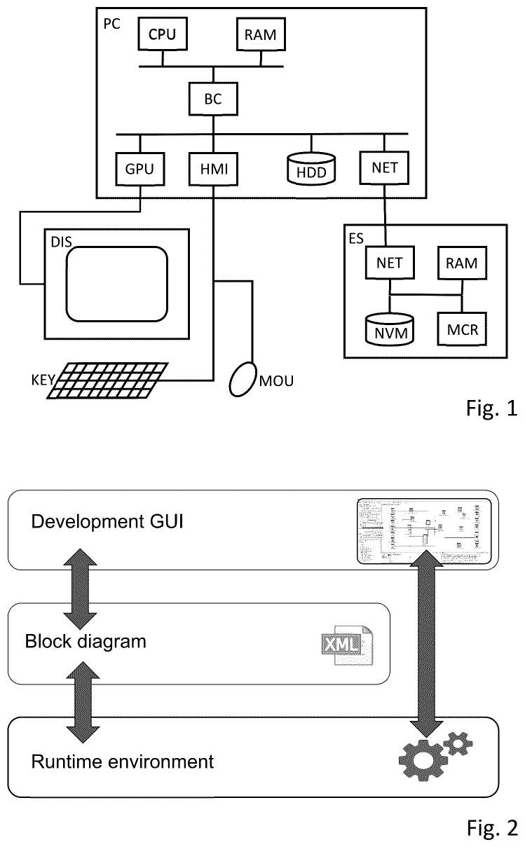

FIG. 1 shows an example of a computer system comprising a host PC PC and a control unit ES. The host PC PC has a processor CPU, which can be implemented, in particular, as a multicore processor, a main memory RAM, and a bus controller BC. The host PC is designed to be operated directly and manually by a user, wherein preferably a monitor DIS is connected through a graphics card GPU, and a keyboard KEY and a mouse MOU are connected through a peripheral interface HMI. In principle, the human-machine interface of the host PC could also be designed as a touch interface. The host PC additionally includes a non-volatile data memory HDD, which can be designed, in particular, as a hard disk drive and/or a solid state disk, as well as an interface NET, in particular a network interface. A control unit ES can be connected through the interface NET. In principle, one or more interfaces of any desired type, in particular wired interfaces, can be present on the computer system PC and can each be usable for the connection to a control unit ES. Expediently, a network interface according to the Ethernet standard can be used; the interface NET can also be implemented wirelessly, in particular as, e.g., a WLAN interface or according to a standard such as Bluetooth.

The control unit ES can be designed, for example, as an RCP system, as a production control unit, or as an evaluation board for a target platform. Expediently, it includes an interface NET for connection to the computer system PC, a microcontroller MCR with a different architecture from the processor of the computer system, a main memory RAM, and a non-volatile memory NVM. The control unit ES need not be permanently connected to the host PC, but instead, provision can also be made that, for example, the recording is carried out only by means of the control unit ES; a connection to the host PC can then be carried out later in order to copy the data. Alternatively, a server that has, e.g., a storage capacity suitable for relatively large quantities of data and that is connected solely through a network can also be provided as an additional part of the computer system.

In FIG. 2, a development environment is represented schematically. The development environment includes a development GUI, which is to say a user interface, in which block diagrams can be displayed and edited.

The interconnection of different components with the existing sensors is specified in a block diagram, which can be stored as, in particular, an XML file. The signal processing chain is thus implemented by means of multiple components in the block diagram. The individual components can be incorporated in the relevant component as compiled binary files so that implementation in different programming languages can take place. The signal processing chain is therefore independent of details of the implementation of individual components.

The block diagram is read and is executed in a runtime environment that can provide the sensor data with time stamps and forward them in a time-synchronized manner.

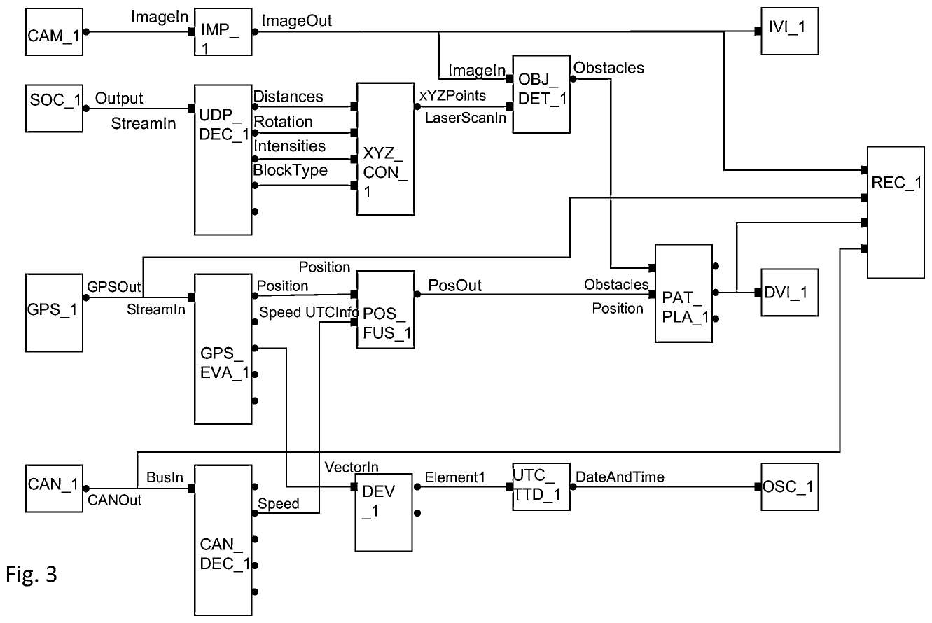

FIG. 3 shows a first example of a block diagram for processing sensor data, in which multiple sources of sensor data are represented on the left side, multiple processing components in the middle, and components for the display and storage of sensor data on the right side.

A component CAM_1 for controlling a camera supplies images, which are delivered to an input ImageIn of an image processing component IMP_1. The image processing component IMP_1 can, for example, adjust the brightness of an image on the basis of a histogram or apply various computer vision algorithms to the image. The output ImageOut of the image processing component is connected to a display component IVI_1, which displays the image for a user.

Data from a LIDAR sensor are received through a socket SOC_1 and delivered to the input Stream In of a decoder component UDP_DEC_1. This component forwards distances through an output Distances, angles of rotation through an output Rotation, which is to say polar coordinates when taken together, the intensities of measurement points through an output Intensities, and additional information through an output BlockType, to a component XYZ_CON_1. The component XYZ_CON_1 creates measurement points in Cartesian coordinates on the basis of the polar coordinates and intensities or converts the LIDAR point cloud into Cartesian coordinates and forwards them to an object detector component OBJ_DET1 through the output XYZPoints.

A component GPS_1 for controlling a satellite navigation receiver forwards GPS data through an output GPSOut to the input Stream In of an evaluation component GPS_EVA_1. The evaluation component GPS_EVA_1 determines a current position, time information, and optionally additional information from the GPS data. The current position is delivered to a component POS_FUS_1 through an output Position. The time information is delivered through an output UTCInfo to the input VectorIn of a component DEV_1.

A component CAN_1 for reading the data from a CAN bus forwards received data packets through an output CANOut to the input BusIn of a decoder component CAN_DEC_1. The decoder component CAN_DEC_1 can extract various information transmitted on the CAN bus, such as, e.g., a current speed, from the data packets. The current speed is delivered through an output Speed to the component POS_FUS_1.

The object detector component OBJ_DET_1 evaluates the received LIDAR point cloud in order to detect objects contained therein. The detected objects are forwarded through an output Obstacles to a planning component PAT_PLA_1. The component POS_FUS_1 combines the current speed and the current position, and forwards the result through the output PosOut to the planning component PAT_PLA_1. From the obstacles and the position, the planning component PAT_PLA_1 determines a trajectory, by means of which actuators of an autonomous vehicle can be controlled, for example. According to the signal processing chain implemented in the block diagram, however, the data obtained are delivered to a recording component REC_1 and additionally are displayed on a screen for a user by means of a display component DVI_1.

The component DEV_1 divides the time information received as a vector and forwards the current time to a conversion component UTC_TTD_1 through an output Element1. The conversion component UTC_TTD_1 converts the current time into a customary display format, such as date and time, before forwarding it to a display component OSC_1 through the output DateAndTime; the display component displays it on a screen.

The output signal ImageOut of the image processing component IMP_1, the output signal GPSOut of the component GPS_1, and the output signal CANOut of the component CAN_1 are additionally delivered to the recording component REC_1. The recording component REC_1 can therefore store the signals received from the various sensors in raw or preprocessed form for later evaluation—or else simple playback—on a non-volatile data carrier, such as a solid state disk or a hard disk drive.

The block diagram represented in FIG. 3 is suitable, for example, for use with a host PC on which initial development steps are performed, wherein simultaneous viewing of the recorded data is also desired.

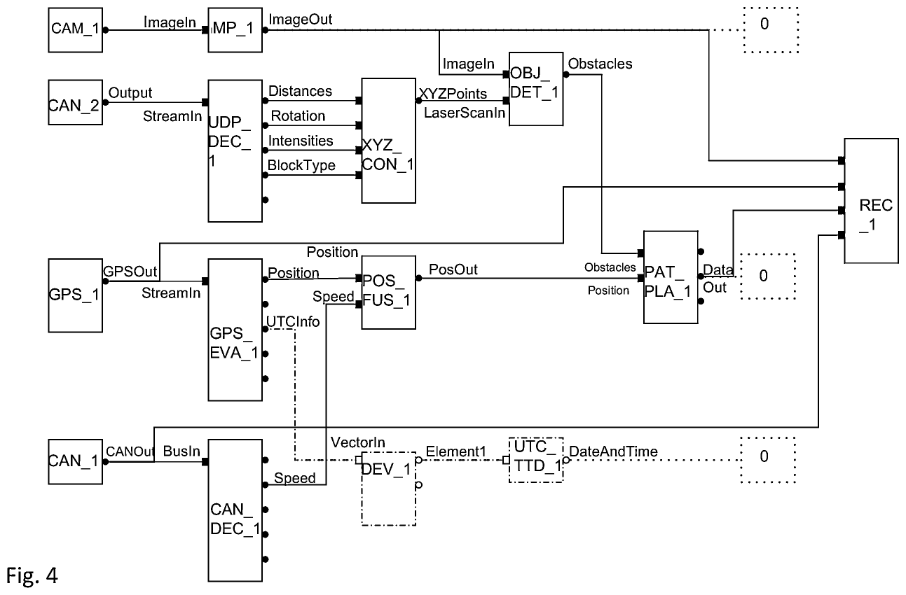

FIG. 4 shows a second example of a block diagram for processing sensor data in which multiple sources of sensor data are represented on the left side, and which includes multiple processing components. The block diagram corresponds in large part to the first example of a block diagram, so primarily the differences are explained below.

Starting from the input components such as CAM_1, the signals are again delivered to processing components such as IMP_1. The display components IVI_1, DVI_1, and OSC_1 are absent, however, which is indicated in the present case by a dotted box 0. The output signal from IMP_1 and the output signal from PAT_PLA_1 are thus delivered only to the recording component REC_1.

With the display component OSC_1 absent, there is also a conversion component whose output was connected solely to the input of OSC_1, namely UTC_TTD_1, which is indicated with a dotted-and-dashed line in the present case. Consequently, conversion component UTC_TTD_1 is no longer required and can be automatically removed. After the removal of UTC_TTD_1 there is yet another component, DEV_1, that is connected on the output side solely to a component that has been removed or is no longer required. Consequently, component DEV_1 is likewise no longer required and can be removed, which is indicated with a dotted-and-dashed representation in the present case. The input of DEV_1 was connected to evaluation component GPS_EVA_1, which is also connected on the output side to component POS_FUS_1, and therefore is still needed.

The block diagram represented in FIG. 4 for the processing of sensor data is suitable, for example, for use in an RCP system, which in particular has no components for interaction such as a screen.

Starting from the block diagram in FIG. 3, the profile specified in Listing 1 can be used for adapting the block diagram to that shown in FIG. 4.

Listing 1:

IVI_1 := 0;
DVI_1 := 0;
OSC_1 := 0;

The identifier “:=0” here means a mapping to an empty component or the removal of the component in question. The components UTC_TTD_1 and DEV_1 can be removed automatically. Provision can also be made, however, for the transitively removable components to be determined in an analysis step and likewise listed in the profile for the adaptation. The profile can be stored in the form of a configuration file, such as an XML file or a comma-separated list, on the host PC or in a version management system.

In addition to the changes shown, provision can also be made that a component such as, for example, the input component CAM_1 can be replaced on account of the use of a different camera type. Then a line such as the following can be added to the profile from Listing 1: CAM_1:=CAM_X;

Here, a replacement is specified through the identifier “:=” with an indication of the component to be inserted. The identifier used is merely an example; the syntax of the profile can be predefined as desired. The substitution of other input components and/or a processing or conversion component can also be provided and specified through an appropriate entry in the profile.

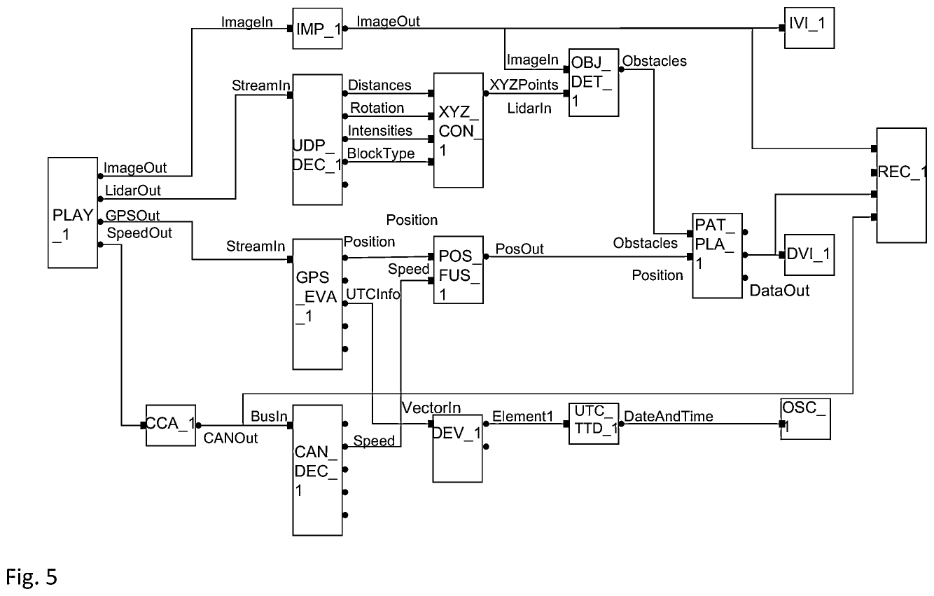

FIG. 5 shows a third example of a block diagram for processing sensor data in which a different source of sensor data is represented on the left side, but which still includes multiple processing components. As in FIG. 3, the block diagram includes some display components. Here again, primarily the differences are explained, while the components that remain the same in comparison with the preceding block diagrams are not described further.

In this block diagram, only a single signal source is present, namely a playback component PLAY_1, which can, for example, reproduce previously recorded data from a camera, a LIDAR sensor, and/or other sensors, or retrieve them from a data carrier. The playback component PLAY_1 has multiple output ports ImageOut, LidarOut, GPSOut, and SpeedOut, which are connected to the input ports of various components. The output port SpeedOut is additionally connected to a conversion component CCA_1, which transforms the speed sensor signal stored on the data carrier, for example, into the form required by the subsequent processing component CAN_DEC_1.

Starting from the block diagram shown in FIG. 3, the profile specified in Listing 2 can be used for adapting the block diagram to that shown in FIG. 5.

Listing 2:

CAM_1 := PLAY_1;
SOC_1 := 0;
GPS_1 := 0;
CAN_1 := CCA_1;
PLAY_1.ImageOut -> IMP_1. ImageIn;
PLAY_1. LidarOut -> UDP_DEC_1.StreamIn;
PLAY_1.GPSOut -> GPS_EVA_1.StreamIn;
PLAY_1.SpeedOut -> CCA_1.In;

In addition to the identifier “:=” for specifying the substitution of a component, an identifier “->” is used here for specifying a connection between two ports. In principle, other identifiers can also be used or a signal-by-signal or port-by-port replacement can be specified.

The block diagram shown in FIG. 5 is suitable, for example, for use in data replay tests on a host PC.

During the development of a control unit, different use cases can arise in which a change between different hardware platforms takes place so that a signal processing chain must be adapted between a first mode and a second mode through a replacement and/or removal of blocks.

In a first use case, a control strategy can be developed on the host PC that is subsequently tested on an RCP system. Expediently, a signal processing chain is therefore implemented in a block diagram as in FIG. 3 for a first mode. Then the control strategy can be developed with the sensors connected to the host PC. As soon as the control strategy has reached a certain degree of maturity, a test can take place in a realistic environment on an RCP system. For this second mode, the block diagram can be adapted as shown in Listing 1.

In a second use case, the measurement data for a driving situation can be recorded by means of an RCP system; the data are subsequently reproduced on a host PC for development and/or testing of a new control strategy. Expediently, a signal processing chain is therefore implemented in a block diagram as in FIG. 4 for a first mode (this use case). It should be noted here that the components and signal connections shown in dotted or dotted-and-dashed lines are not part of the block diagram. The measurement data required for a test of the control algorithm can be recorded in real drives. The test can then take place on the host PC in a second mode by means of a block diagram as shown in FIG. 5. Starting from the block diagram in FIG. 4, the profile specified in Listing 3 can be used for adapting the block diagram to that shown in FIG. 5.

Listing 3:

CAM_1 := PLAY_1;
SOC_1 := 0;
GPS_1 := 0;
CAN_1 := CCA_1;
PLAY_1.ImageOut -> IMP_1. ImageIn;
PLAY_1. LidarOut -> UDP_DEC_1.StreamIn;
PLAY_1.GPSOut -> GPS_EVA_1.StreamIn;
PLAY_1.SpeedOut -> CCA_1.In;
0 := IVI_1;
0 := DVI_1;
0 := DEV_1;
0 := UTC_TTD_1;
0 := OSC_1;
IMP_1.ImageOut -> IVI_1.In;
PAT_PLA_1.DataOut -> DVI_1.In;
GPS_EVA_1.UTCInfo -> DEV_1.VectorIn;
DEV_1.Element1 -> UTC.TTD.In;
UTC_TTD_1.DateAndTime -> OSC_1.In;

Here, the insertion of a component has been formulated as a substitution “:=” of an empty component “0”. In principle, other notations can also be used.

In a third use case, parameters of a component can be substituted by means of the profile. For example, a generic camera driver component can be present that can interoperate with different camera types. By means of the profile, a configuration parameter can then be transferred or changed in order to, e.g., switch from a camera connected by USB (which can be connected to the host PC) to a camera connected via CAN bus (which can be connected to the RCP system). For this purpose, the component, the parameter, and the new value for a specific mode can be specified in the profile.

By means of the formalism described, a block diagram with multiple profiles can thus be used to cover different use cases or target platforms. If it is now necessary, for example, to switch from an RCP system back to a host PC on account of a fault in order to permit debugging, then the block diagram can simply be reloaded. A subsequent switch to the RCP system merely requires a loading of the block diagram and use of the appropriate profile. In principle, it is also possible to arbitrarily choose the initial profile. The selection of use case or target platform can be accomplished manually or be accomplished automatically, for example on the basis of a hardware ID stored in the profile.

The method according to the invention consequently makes it possible to execute multi-sensor applications on different hardware platforms with little effort.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A computer-implemented method for modifying a signal processing chain that is implemented in a block diagram via components connected by signal lines, the block diagram including at least one signal source and at least two components that are connected directly or by interposed components to at least one of the signal sources, the method comprising:
reading the block diagram into a development environment;
selecting a mode from at least two existing modes, wherein the signal processing takes place on a first hardware platform or a host PC, in a first mode and the signal processing takes place on a second hardware platform or an RCP system, in a second mode, wherein the first hardware platform and the second hardware platform are designed differently; and
removing or replacing at least a first component from the block diagram if the second mode was chosen.

2. The method according to claim 1, further comprising removing at least one additional component if the first component was removed and the additional component was connected solely to the first component on the output side.

3. The method according to claim 1, wherein the selection of a mode takes place automatically on the basis of a hardware platform that executes a runtime environment of the development environment.

4. The method according to claim 1, wherein a third mode is selected through the development environment, wherein the third mode includes an execution on a third hardware platform, in particular a production control unit, and wherein a generation of source code from the block diagram additionally takes place in the third mode.

5. The method according to claim 1, further comprising reading a configuration file that includes at least one mapping of a component of the block diagram onto another component or a mapping onto an empty component or includes a removal of the component, and wherein the at least one mapping is specific for one mode.

6. The method according to claim 1, wherein the development environment includes a runtime environment that is equipped to provide signal data received through a signal source with at least one time stamp, and wherein the components and/or the runtime environment are equipped to process signal data in a synchronized manner.

7. A method for testing a control unit, the method comprising:
opening a block diagram on a first hardware platform or a host PC, wherein at least a first signal source in the block diagram is executed as a playback component;
executing the block diagram on the first hardware platform in order to obtain at least a first result; and
comparing the first result with a test condition, and if the first test condition is met:
reading a configuration file that includes a mapping of the first signal source to a component for controlling a real sensor;
adapting the block diagram on the basis of the configuration file, wherein the adaptation of the block diagram includes the replacement of the playback component by the component for controlling a real sensor;
downloading the modified block diagram to a second hardware platform or an RCP system; and
executing the block diagram on the second hardware platform in order to obtain a result based on real sensor data.

8. A method for configuring a control unit, the control unit comprising at least one computing unit and at least one sensor and/or at least one actuator in order to sense data of a physical process and/or to influence the process, the method comprising:
generating source code according to the method of claim 4;
compiling the source code for the computing unit so that executable code is generated;
transmitting the executable code to the control unit; and
storing the executable code on a non-volatile memory of the control unit and/or executing the executable code by the computing unit of the control unit.

9. The computer program product with a computer-readable storage medium on which instructions are embedded that, when they are executed by a processor, cause the processor to carry out the method according to claim 1.

10. A computer system comprising a human-machine interface, a non-volatile memory, and a processor, wherein the processor is equipped to carry out the method according to claim 1.
